(19) United States
(12) Patent Application Publication
(10) Pub. No.: US 2019/0192258 A1
(43) Pub. Date: Jun. 27, 2019

(54) AUTOMATIC STEPWISE TOOTH MOVEMENT SYSTEM AND METHOD USING ARTIFICIAL INTELLIGENCE TECHNOLOGY

(71) Applicant: CLEARLINE.CO.LTD, Seoul (KR)

(72) Inventors: Je Hun KANG, Seoul (KR); Kweon Seok KANG, Seoul (KR); Eui Joong KIM, Seongnam-si (KR)

(21) Appl. No.: 15/919,308

(22) Filed: Mar. 13, 2018

(30) Foreign Application Priority Data
Dec. 27, 2017 (KR) 10-2017-0181450
Feb. 1, 2018 (KR) 10-2018-0013068

(51) Int. Cl. A61C 7/00; A61C 7/08; G06F 15/18

(52) U.S. Cl. CPC A61C 7/002; G06F 15/18; A61C 7/08

(57) ABSTRACT

Disclosed is a stepwise automatic orthodontic system and method using an artificial intelligence technique. The method includes: scanning a dental state of a patient by using an intraoral scanner; allowing a server to determine to which group of grouped data of the database the scanned dental data belong; allowing the server to refer to data of the determined group, move a tooth needing orthodontics gradually, and generate a predictive digital orthodontic dental data set; allowing the server to transmit the orthodontic-processed digital orthodontic dental data set of a patient to a 3D printer, and allowing the 3D printer to generate and output a dental orthodontic model; and generating a clear aligner by vacuum-compressing a transparent synthetic resin plate to the generated dental orthodontic model through a vacuum former. In the exemplary embodiment of the present invention, the orthodontic patient is clustered or grouped through an unsupervised learning based on the good orthodontic data excluding personal information of the patient, and the tooth moving plan for orthodontics through repeated reinforcement learning satisfying the orthodontic limit condition suggested by the grouped data and the orthodontics textbook for respective steps.

### CROSS-REFERENCE TO RELATED APPLICATION

This application claims priority to and the benefit of Korean Patent Application No. 10-2017-0181450 filed in the Korean Intellectual Property Office on Dec. 27, 2017 and No. 10-2018-0013068 filed in the Korean Intellectual Property Office on Feb. 01, 2018, the entire contents of which are incorporated herein by reference.

### BACKGROUND OF THE INVENTION

### (a) Field of the Invention

The present invention relates to an automatic tooth moving system according to a computer algorithm. More particularly, the present invention relates to a stepwise automatic orthodontic system and method using an artificial intelligence technique for defining an orthodontic standard of a patient through unsupervised learning with a recorded good orthodontic record by use of a machine learning method that is an artificial intelligence technique, and applying an automatic orthodontic algorithm satisfying an orthodontic recommendation or a limit condition provided by an orthodontics textbook to a reinforcement learning scheme.

### (b) Description of the Related Art

Clear aligners are typically manufactured by taking 3D scans of impressions of a patient's teeth and then processing the 3D scan data to create a series of digital data for orthodontic treatment through an orthodontic treatment program to incrementally reposition teeth until a final tooth arrangement is achieved. Using the data created for orthodontic treatment, teeth molds are made for each stage and then vacuum-pressed, thereby manufacturing a set of clear aligners for incremental tooth movements.

The issue with the conventional orthodontic data provision method is that errors can occur between the actual and predicted tooth movements because of incorrect predictions made through the process of creating digital data for orthodontic treatment. This may result in movement of the teeth beyond what would be clinically relevant, thus causing damage to the teeth's nerves.

In addition, artificial intelligence is used in a wide range of study fields, such as voice and vision recognition, natural language processing, robotics, expert systems, deduction, and learning.

Artificial intelligence realizes a “system that behaves like humans,” and is a field of computer engineering and information technology for allowing computers to do thinking, learning, and self-development as with human intelligence.

The artificial intelligence techniques are applied to fields such as self-driving cars, robotics, playing baduk/chess, and computer vision that exist in various industries and lives.

### PRIOR ART

### Patent

(Patent document 1) Korea Patent 10-1463422 (Registered date: Nov. 13, 2014: Clear aligner and manufacturing method appropriate for the same)

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a stepwise automatic orthodontic system and method for clustering or grouping orthodontic patients through unsupervised learning based on good orthodontic data excluding personal information of a patient, and establishing a tooth moving plan for orthodontics through repeated reinforcement learning satisfying an orthodontic limit condition suggested by the grouped data and an orthodontics textbook.

The present invention has been made in another effort to provide a stepwise automatic orthodontic system and method using an artificial intelligence technique for coating transparent silicone inside a synthetic plate so that it may be smoothly attached to teeth, thereby increasing the orthodontic effect and protecting the gums.

The present invention has been made in another effort to provide a stepwise automatic orthodontic system and method using an artificial intelligence technique for preventing a cavity by coating fluoride inside the synthetic plate.

The present invention has been made in another effort to provide a stepwise automatic orthodontic system and method using an artificial intelligence technique for preventing infection of the gums by coating hexamedine inside the synthetic plate. An exemplary embodiment of the present invention provides a stepwise automatic orthodontic system including: a database for storing good orthodontic data excluding personal information of a patient, data generated by clustering orthodontic patients or dividing them into a predetermined number of groups through unsupervised learning based on the orthodontic data, and an orthodontic limit condition presented by an orthodontics textbook; an artificial intelligence orthodontic data generator for determining to which group from among the grouped data of the database the orthodontic data generated by 3D-scanning the orthodontic state of an orthodontic patient belongs, referring to the data of the determined group, gradually moving a tooth that needs orthodontics to generate a predictive digital orthodontic data set, and classifying the predictive digital orthodontic data set into a unit digital aligning data group; an artificial intelligence orthodontic data determiner for comparing unit orthodontic-based data of a patient after a clear aligner manufactured corresponding to the unit digital aligning data group is worn and the predictive digital orthodontic data set for each the unit digital aligning data group; and an artificial intelligence controller for assigning a positive point when the unit orthodontic state data of the patient correspond to the predictive digital aligning data set, and assigning a negative point when the unit orthodontic state data of the patient do not correspond to the predictive digital aligning data set through the artificial intelligence aligning data determiner, and storing the point in the database.

When a sum of assigned points becomes greater than a predetermined number of points, the artificial intelligence controller stores the same in the database as good orthodontic data excluding personal information of the patient.

When the unit orthodontic state data of the patient do not correspond to the predictive digital aligning data set through the aligning data determiner, the artificial intelligence controller controls to generate a new predictive digital orthodontic data set corresponding to a difference between the unit orthodontic state data of the patient and the predictive digital aligning data set.

When the unit orthodontic state data of the patient do not correspond to the predictive digital aligning data set through the aligning data determiner, the artificial intelligence controller controls to generate a new predictive digital orthodontic data set corresponding to a difference between the unit orthodontic state data of the patient and the predictive digital aligning data set and control data of a dentist, and outputs age, gum state, or cavity information of the patient.

The stepwise automatic orthodontic system further includes: a three-dimensional (3D) printer for generating and outputting an orthodontic model by using the digital orthodontic data; a vacuum former for generating a clear aligner by vacuum-compressing a transparent synthetic resin plate on which a transparent silicone is coated to the generated orthodontic model; and a coating device for coating fluorine or hexamedine on the clear aligner generated by the vacuum former.

The coating device includes: a communicator for receiving patient information from the artificial intelligence controller; a fluoric solution storage unit for storing a fluoric solution; a hexamedine solution storage unit for storing a hexamedine solution; a fluoric solution sprayer for spraying the fluoric solution of the fluoric solution storage unit; a hexamedine sprayer for spraying the hexamedine solution of the hexamedine solution storage unit; and a coating controller for receiving the age, gum, or cavity information of the patient through the communicator, controlling to coat the hexamedine solution on the clear aligner when the patient has gum disease, and controlling to coat the fluoric solution on the clear aligner when the patient has a cavity.

The coating controller receives changing information of the age, gum, or cavity information of the patient through the communicator, controls an amount of the hexamedine solution and controls to coat the same on the clear aligner according to a variation of gum disease information of the patient, and controls an amount of the fluoric solution and controls to coat the same on the clear aligner according to a variation of cavity information of the patient.

When the patient has a cavity and gum disease, the coating controller controls the amount of the fluoric solution and coats the same on the clear aligner, and it controls the amount of the hexamedine solution and coats the same on a gum contact portion of the clear aligner.

When the gum disease of the patient is determined to improve, the coating controller reduces the amount of the hexamedine solution and coats the same on the clear aligner.

When the gum disease of the patient is determined to become worse, the coating controller increases the amount of the hexamedine solution and coats the same on the clear aligner.

When the cavity of the patient is determined to improve, the coating controller reduces the amount of the fluoric solution and coats the same on the clear aligner.

When the cavity of the patient is determined to become worse, the coating controller increases the amount of the fluoric solution and coats the same on the clear aligner.

When the age of the patient is equal to or greater than 40, the coating controller controls to coat a hexamedine solution on the clear aligner, and when the age of the patient is less than 40, the coating controller controls to coat a fluoric solution on the clear aligner.

When the unit orthodontic state data of the patient do not correspond to the predictive digital aligning data set through an aligning data determiner, the artificial intelligence controller provides unit orthodontic state data of the patient and the predictive digital aligning data set to a dentist terminal, and receives control data of the dentist.

When the unit orthodontic state data of the patient do not correspond to the predictive digital aligning data set through the aligning data determiner, the artificial intelligence controller provides a newly generated predictive digital aligning data set corresponding to the difference between the unit orthodontic state data of the patient and the predictive digital aligning data set to the dentist terminal, and receives control data of the dentist from the dentist terminal.

When the unit orthodontic state data of the patient show movement of more than the predictive digital aligning data set, the artificial intelligence controller generates new digital aligning data corresponding to a movement.

Another embodiment of the present invention provides a stepwise automatic orthodontic method using an artificial intelligence technique, including: scanning an orthodontic state of a patient by using an intraoral scanner; allowing a server to determine to which group of grouped data of the database the scanned orthodontic data belong; allowing the server to refer to data of the determined group, move a tooth needing orthodontics gradually, and generate a predictive digital orthodontic data set; allowing the server to transmit the orthodontic-processed digital orthodontic data set of a patient to a three-dimensional (3D) printer, and allowing the three-dimensional (3D) printer to generate and output an orthodontic model; and generating a clear aligner by vacuum-compressing a transparent synthetic resin plate to the generated orthodontic model through a vacuum former.

The method further includes: allowing a coating device to receive age, gum state, or cavity information of the patient from the server through a communicator; when the patient has gum disease, allowing the coating device to coat a hexamedine solution on the clear aligner; and when the patient has a cavity, allowing the coating device to coat a fluoric solution on the clear aligner.

When the patient has a cavity and gum disease, the server controls an amount of the fluoric solution and coats the same on the clear aligner, and it controls an amount of the hexamedine solution and coats the same on a gum contact portion of the clear aligner.

According to the exemplary embodiment of the present invention, the stepwise automatic orthodontic system and method for clustering or grouping orthodontic patients through unsupervised learning based on the good orthodontic data excluding personal information of a patient, and establishing the tooth moving plan for orthodontics through repeated reinforcement learning satisfying the orthodontic limit condition suggested by the grouped data and the orthodontics textbook, may be provided.

Further, according to the exemplary embodiment of the present invention, the stepwise automatic orthodontic system and method using an artificial intelligence technique for coating transparent silicone inside the synthetic plate so that it may be smoothly attached to the teeth, thereby increasing the orthodontic effect and protecting the gum, may be provided.

Also, according to the exemplary embodiment of the present invention, the stepwise automatic orthodontic system and method using an artificial intelligence technique for preventing the cavity by coating fluoride inside the synthetic plate may be provided.

In addition, according to the exemplary embodiment of the present invention, the stepwise automatic orthodontic system and method using an artificial intelligence technique for preventing the infection of the gum by coating hexamedine inside the synthetic plate may be provided.

### BRIEF DESCRIPTION OF THE DRAWINGS

FIG. 1 shows a stepwise automatic orthodontic system using an artificial intelligence technique according to an exemplary embodiment of the present invention.

FIG. 2 shows a coating device of FIG. 1.

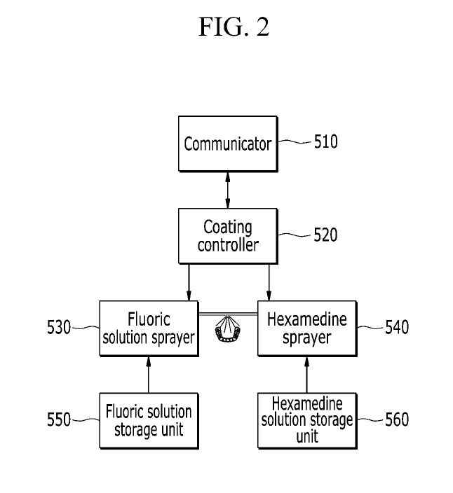

FIG. 3 shows a learning process in a stepwise automatic orthodontic method using an artificial intelligence technique according to an exemplary embodiment of the present invention.

FIG. 4 shows a process for generating new predictive digital orthodontic data in a stepwise automatic orthodontic method using an artificial intelligence technique according to an exemplary embodiment of the present invention.

FIG. 5 shows generation of orthodontic dental data of FIG. 4, in detail.

FIG. 6 shows a process for comparing results after stepwise orthodontics, and generating orthodontic data in a stepwise automatic orthodontic method using an artificial intelligence technique according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive, and like reference numerals designate like elements throughout the specification.

Unless explicitly described to the contrary, the word “comprise” and variations such as “comprises” or “comprising” will be understood to imply the inclusion of stated elements but not the exclusion of any other elements. The suffixes “-er” and “-or” and the term “module” described in the specification mean units for processing at least one function or operation, and can be implemented by hardware or software and combinations thereof.

A server to be described hereinafter may be realized by a processor and a memory.

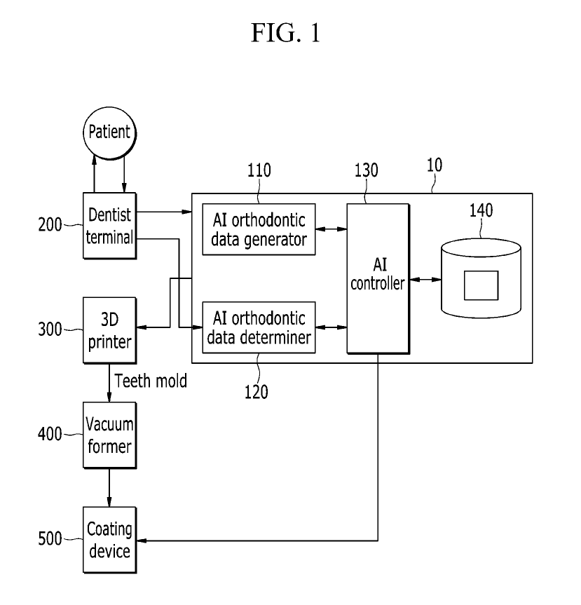

FIG. 1 shows a stepwise automatic orthodontic system using an artificial intelligence technique according to an exemplary embodiment of the present invention.

Referring to FIG. 1, the stepwise automatic orthodontic system using an artificial intelligence technique according to an exemplary embodiment of the present invention includes:

a database 140 for storing good dental orthodontic data excluding personal information of a patient, data generated by clustering dental orthodontic patients or dividing them into a predetermined number of groups through unsupervised learning based on the dental orthodontic data, and a dental orthodontic limit condition presented by a dental orthodontics textbook;

an artificial intelligence orthodontic data generator 110 for determining to which group from among the grouped data of the database 140 the dental data generated by 3D-scanning the dental state of a dental patient belongs, referring to the data of the determined group, gradually moving a tooth that needs correction to generate a predictive digital orthodontic dental data set, and classifying the predictive digital orthodontic data set into a unit digital aligning data group;

an artificial intelligence orthodontic data determiner 120 for comparing unit orthodontic-based dental data of a patient after a clear aligner manufactured corresponding to the unit digital aligning data group is worn with the predictive digital orthodontic dental data set for each unit digital aligning data group; and an artificial intelligence controller 130 for assigning a positive point when the unit orthodontic dental state data of the patient correspond to the predictive digital aligning data set, and assigning a negative point when the unit orthodontic dental state data of the patient do not correspond to the predictive digital aligning data set through the artificial intelligence aligning data determiner 120, and storing the point in the database.

When a sum of the assigned points becomes greater than a predetermined number of points, the artificial intelligence controller 130 stores the same in the database 140 as good dental orthodontic data excluding personal information of the patient.

When the unit orthodontic state data of the patient do not correspond to the predictive digital aligning data set through the artificial intelligence aligning data determiner 120, the artificial intelligence controller 130 controls to generate a new predictive digital orthodontic data set corresponding to a difference between the unit orthodontic state data of the patient and the predictive digital aligning data set.

When the unit orthodontic state data of the patient do not correspond to the predictive digital aligning data set through the artificial intelligence aligning data determiner 120, the artificial intelligence controller 130 controls to generate a new predictive digital orthodontic data set corresponding to a difference between the unit orthodontic state data of the patient and the predictive digital aligning data set, and control data of a dentist, and outputs an age, a gum state, or cavity information of the patient.

The artificial intelligence controller 130 further includes: a three-dimensional (3D) printer 300 for generating and outputting a dental orthodontic model by using the digital orthodontic data if needed;

a vacuum former 400 for generating a clear aligner by vacuum-compressing a transparent synthetic resin plate on which a transparent silicone is coated to the generated orthodontic model; and

a coating device 500 for coating fluorine or hexamedine on the clear aligner generated by the vacuum former 400.

The coating device 500 includes:

a communicator 510 for receiving patient information from the data generating controller 130;

a fluoric solution storage unit 550 for storing a fluoric solution;

a hexamedine solution storage unit 560 for storing a hexamedine solution;

a fluoric solution sprayer 530 for spraying the fluoric solution of the fluoric solution storage unit;

a hexamedine sprayer 540 for spraying the hexamedine solution of the hexamedine solution storage unit; and

a coating controller 520 for receiving the age, gum, or cavity information of the patient through the communicator 510, controlling to coat the hexamedine solution on the clear aligner when the patient has gum disease, and controlling to coat the fluoric solution on the clear aligner when the patient has a cavity.

The coating controller 520 receives changing information of the age, gum, or cavity information of the patient through the communicator, controls an amount of the hexamedine solution and controls to coat the same on the clear aligner according to a variation of gum disease information of the patient, and controls an amount of the fluoric solution and controls to coat the same on the clear aligner according to a variation of cavity information of the patient.

When the patient has a cavity and gum disease, the coating controller 520 may control the amount of the fluoric solution and may coat the same on the clear aligner, and it may control the amount of the hexamedine solution and may coat the same on a gum contact portion of the clear aligner.

When the gum disease of the patient is determined to improve, the coating controller 520 may reduce the amount of the hexamedine solution and may coat the same on the clear aligner.

When the gum disease of the patient is determined to become worse, the coating controller 520 may increase the amount of the hexamedine solution and may coat the same on the clear aligner.

When the cavity of the patient is determined to improve, the coating controller 520 may reduce the amount of the fluoric solution and may coat the same on the clear aligner.

When the cavity of the patient is determined to become worse, the coating controller 520 may increase the amount of the fluoric solution and may coat the same on the clear aligner.

When the age of the patient is equal to or greater than 40, the coating controller 520 may control to coat the hexamedine solution on the clear aligner, and when the age of the patient is less than 40, the coating controller 520 may control to coat the fluoric solution on the clear aligner.

Further, according to an exemplary embodiment of the present invention, fluorine may be coated on the tooth so as to prevent dental caries and cavities.

Here, methods for coating teeth by use of fluorine include expert fluorine coating and self-fluorine coating, and the fluoride to be coated includes sodium fluoride, stannous fluoride, and acidulated phosphate fluoride.

When the unit orthodontic state data of the patient do not correspond to the predictive digital aligning data set through the artificial intelligence aligning data determiner 120, the artificial intelligence controller 130 may provide a newly generated predictive digital aligning data set corresponding to the difference between the unit orthodontic state data of the patient and the predictive digital aligning data set to a dentist terminal 200, and may receive control data of the dentist from the dentist terminal 200.

When the unit orthodontic state data of the patient moves further than the predictive digital aligning data set does, new digital aligning data may be generated corresponding to a shift.

A method for the artificial intelligence aligning data determiner 120 to assign a positive point or a negative point may be realized in various ways.

For example, the points may be assigned by comparing the scanned dental states. That is, compensation points may be assigned according to contacting sites or bite problems of teeth.

The compensation points may be assigned according to bite curves.

That is, compensation points may be assigned according to a smile line model of the maxilla, a curve of incisal edge in an anterior portion of the mandible, a curve of Spee that is a front and rear curve on a sagittal plane, and a curve of Wilson that is a tone curve on a frontal plane.

In addition, compensation points caused by dental shift plasticity and pain feedback of patients may be considered. For example, when a force is applied to the tooth, the gum that is hardened in an earlier stage digresses from the elastic limit as time passes, and tissues are accordingly transformed so that they may easily move, and a transformation degree of the fiber tissues is expected to be different depending on sex and age characteristics. Therefore, a tooth that has a short moving distance before/after orthodontics may reach an ideal value with a relatively short step. However, a pain degree of the patient is assumed to reduce as the total force applied to the tooth becomes less, and it may increase the satisfaction of the patient to divide this step into stages and gradually move within a predetermined stage.

Therefore, calculation of force according to a transformation matrix applied to respective teeth and calculation results may be used as compensation values.

According to an exemplary embodiment of the present invention, weight values may be finally assigned to the compensation factors, and compensation points may be synthetically calculated.

An operation of the above-configured automatic orthodontic system using an artificial intelligence technique according to an exemplary embodiment of the present invention will now be described.

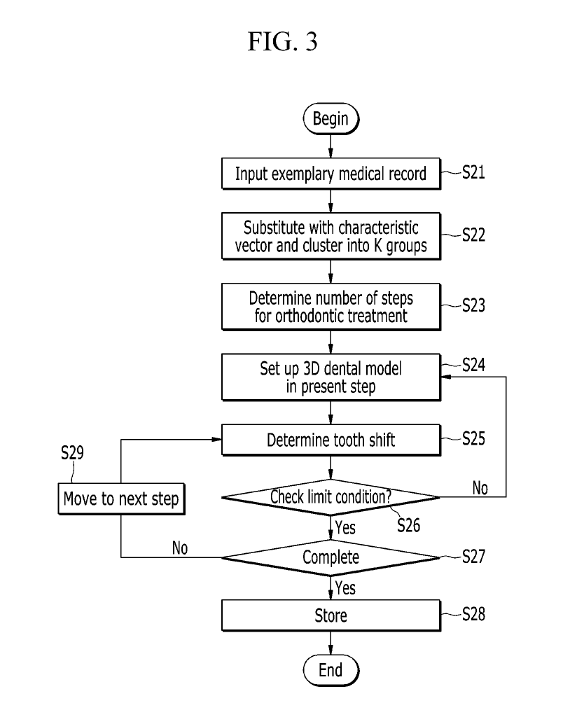

FIG. 3 shows a learning process in a stepwise automatic orthodontic method using an artificial intelligence technique according to an exemplary embodiment of the present invention.

Referring to FIG. 3, a server 10 using an artificial intelligence technique reads an exemplary medical record with a good orthodontic treatment (S21).

The server 10, using an artificial intelligence technique, defines quantitative characteristics (e.g., an arrangement arch of teeth, a distance between molars, and a correlation distance between a molar and an incisor) of teeth arrangement defined by the sex/age/(race)/stature/weight/orthodontics of the corresponding patient to be a value d, substitutes the same with a characteristic vector, and positions the same in a d-dimensional space.

For example, the characteristic vector may be substituted with xₙ ∈ R^{d}.

Here, n represents the entire number of obtained good aligning data.

After this, to extract important factors, the dimension is reduced through principal component analysis (PCA) and is clustered into k-numbered groups by using an unsupervised learning algorithm (e.g., a k-means, a DBSCAN, or a hierarchical cluster) (S22).

When grouped in this way, it is possible to know to which type of group the patient belongs based on newly input patient data.

When the group to which the patient belongs is known, the considered limit condition and the primary orthodontic plan may be established by referring to the finished good orthodontic data.

The server 10 using an artificial intelligence technique determines the number of steps needed for an orthodontic treatment of the patient group with reference to orthodontic data of the corresponding good group (S23).

The server 10 using an artificial intelligence technique sets up a 3D dental model from the first step to store the same in the database 140 (S24).

The server 10 using an artificial intelligence technique determines a tooth shift (S25). In this instance, an algorithm of the server 10 using an artificial intelligence technique may attempt various shifts for dental orthodontics in respective stages.

The server 10 using an artificial intelligence technique checks whether a limit condition on a tooth shift of the corresponding step is satisfied (S26).

That is, it determines whether the tooth shift satisfies the limit condition, a recommendation, or a guideline suggested by the orthodontics for respective tooth shifts.

For example, an alignment, a marginal ridge, a buccolingual inclination, an occlusal contact, an occlusal relationship, an interproximal space, and an overjet may be considered as the limit condition.

When the limit condition is satisfied, the server 10, using an artificial intelligence technique, determines whether the predictive digital aligning data set is completed (S27).

When the predictive digital aligning data set is not completed, the server 10, using an artificial intelligence technique, switches to the next step to repeat the steps from the setting up of the 3D dental model (S29).

In the case of completion of all steps, the server 10, using an artificial intelligence technique, stores tooth moving information and target dental model information for respective steps before performing the orthodontics procedure on the patient in the database as a best model for the corresponding group (S28).

By the above-noted process, the server 10 stores aligning data of the best model for respective dental models. In this instance, the process for generating aligning data of the best model may be performed by the artificial intelligence aligning data generator 110 of the server 10.

A process for generating new predictive digital orthodontic data in the stepwise automatic orthodontic method using an artificial intelligence technique when a patient sees the dentist in this state will now be described.

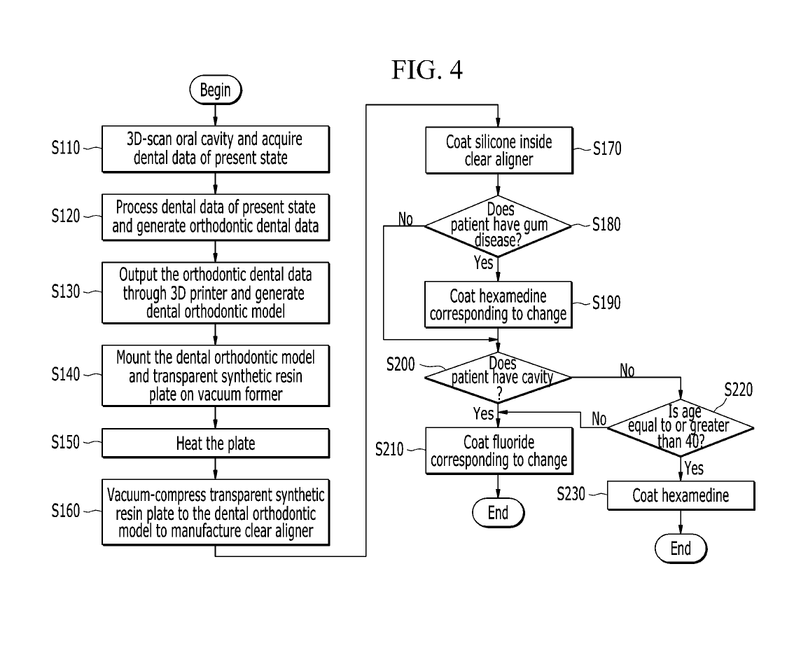

FIG. 4 shows a process for generating new predictive digital orthodontic data in a stepwise automatic orthodontic method using an artificial intelligence technique according to an exemplary embodiment of the present invention.

Referring to FIG. 4, a person in charge in hospital clinic uses an intraoral scanner to 3D-scan an oral cavity of the patient to acquire dental data of the present state (S110).

A dentist uses the scanned dental data and uses a dentist terminal to perform an orthodontic process and generate orthodontic dental data (S120).

If needed, the server 10 uses the artificial intelligence technique and uses the scanned dental data to perform an orthodontic process and generate orthodontic data (S120).

In this instance, the server 10 receives orthodontic processed data from the dentist terminal 200 to store the same in the database 140, or stores the orthodontic data generated by the server 10 in the database 140.

The server 10 transmits the orthodontic-processed aligning data of the patient to the 3D printer 300, and the 3D printer 300 generates a dental orthodontic model (S130).

If needed, a support attached to the generated orthodontic model is firstly removed with a strong water pressure in a cleanser. In a hot oven, the support attached to the orthodontic model is secondly removed. The orthodontic model then becomes clean.

The dental orthodontic model and the plate are mounted on the vacuum former 400 (S140), a transparent synthetic resin plate is heated to the generated dental orthodontic model through the vacuum former 400 (S150), and it is vacuum-compressed to generate a clear aligner (S160). In this instance, if needed, an end of the clear aligner is cut with scissors to allow convenient wearing.

The clear aligner coats a portion contacting a gum and a tooth with transparent silicone (S170). If needed, the process for coating silicone may be omitted.

The clear aligner is provided into a coating device, and the coating device is operated.

The coating device 500 receives the age, the gum state, or cavity information of the patient from the server 10 through the communicator 510.

The controller 520 determines whether a patient has gum disease (S180).

When the patient has gum disease, the coating controller 520 of the coating device 500 controls to coat a hexamedine solution on the clear aligner according to the gum state change of the patient, and the hexamedine sprayer 540 sprays the hexamedine solution (S190). For example, when the gum state of the patient begins to improve, the coating controller 520 reduces the amount of the hexamedine solution and coats with it, and when the gum state of the patient becomes worse, the coating controller 520 increases the amount of the hexamedine solution and coats with it.

Further, the coating controller 520 determines whether the patient has a cavity (S200).

When the patient has a cavity, the coating controller 520 controls to coat a fluoric solution on the clear aligner according to the cavity state change of the patient, and the fluoric solution sprayer 530 sprays the fluoric solution (S210). For example, when the cavity state of the patient improves, the coating controller 520 reduces the amount of the fluoric solution and coats with it, and when the cavity state of the patient becomes worse, the coating controller 520 increases the amount of the fluoric solution and coats with it.

When the patient has no gum disease or cavity, the coating controller 520 determines whether the age of the patient is equal to or greater than 40 (S220).

When the age of the patient is equal to or greater than 40, the coating controller 520 of the coating device controls to coat the hexamedine solution on the clear aligner, and the hexamedine sprayer 540 sprays the hexamedine solution (S230). This may have a preventive effect of the gum disease.

When the age of the patient is less than 40, the controller 520 controls to coat the fluoric solution on the clear aligner, and the fluoric solution sprayer 530 sprays the fluoric solution (S210). This may have a preventive effect of the cavity.

The above-noted process is made up of a predetermined number of sets, substantially five sets.

In the process, the clear aligner may be generated by vacuum-compressing the transparent synthetic resin plate on which transparent silicone is coated to the generated dental orthodontic model through the vacuum former 400, and in this case, the process for coating transparent silicone is omitted.

When the patient has a cavity and gum disease, the coating controller 520 may control the amount of the fluoric solution and may coat the same on the clear aligner, and it may control the amount of the hexamedine solution and may coat the same on the gum contact portion of the clear aligner.

The stage S120 for generating orthodontic data in the above-noted process will now be described in detail.

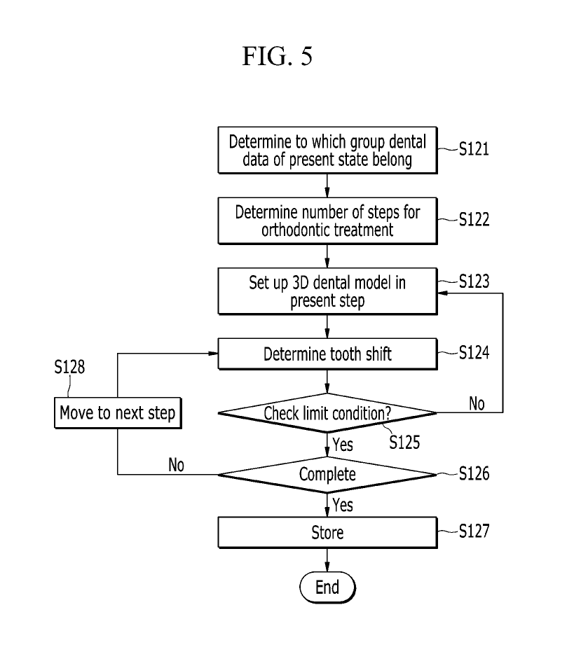

FIG. 5 shows generation of orthodontic data of FIG. 4, in detail.

Referring to FIG. 5, the server 10 analyzes quantitative characteristics (e.g., an arrangement arch of teeth, a distance between molars, and a correlation distance between a molar and an incisor) of the teeth arrangement defined by the sex/age/(race)/stature/weight/orthodontics from present state data and information of the corresponding patient to determine to which group the present state data of the corresponding patient belong (S121).

The server 10 refers to the good orthodontic data of the best model of the group to which the corresponding patient belongs, and determines the number of steps needed for an orthodontic treatment so as to move a tooth from the present state to the target state (S122).

The server 10 sets up the 3D dental model from the first step and stores the same in the database 140 (S123).

The server 10 technique determines a tooth shift (S124). In this instance, an algorithm of the server 10 may attempt various shifts for orthodontics in respective stages.

The server 10 checks whether the limit condition of the tooth shift of the corresponding step is satisfied (S125). That is, it determines whether the tooth shift satisfies the limit condition, a recommendation, or a guideline suggested by the orthodontics for respective tooth shifts.

For example, an alignment, a marginal ridge, a buccolingual inclination, an occlusal contact, an occlusal relationship, an interproximal space, and an overjet may be considered as the limit condition.

When the limit condition is satisfied, the server 10 determines whether the predictive digital dental data set is completed (S126).

When the predictive digital dental data set is not completed, the server 10 switches to the next step to repeat the steps from the setting up of the 3D dental model (S128).

When all steps are performed and the predictive digital dental data set is completed, the server 10 stores tooth shift information and target orthodontic model information in the database for the respective steps before performing orthodontics of the patient for the corresponding group (S127), and performs the next step (S130).

The patient wears the clear aligner at intervals of substantially one to two weeks for respective steps.

The patient goes to the dentist when he has a problem in wearing it or after he has worn it according to the respective steps, and the next flow is as follows.

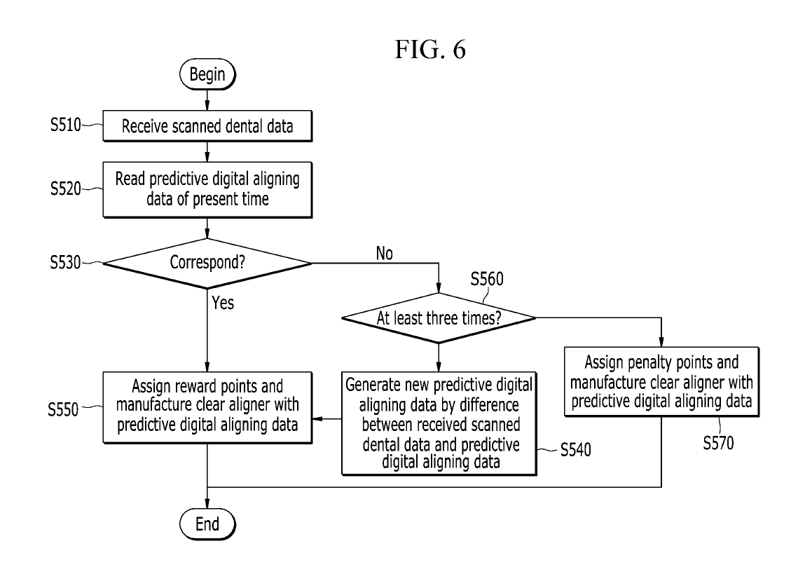

FIG. 6 shows a process for comparing results after stepwise orthodontics, and generating orthodontic data in a stepwise automatic orthodontic method using an artificial intelligence technique according to an exemplary embodiment of the present invention.

Referring to FIG. 6, the dentist scans the intraoral state of the patient with a scanner and transmits scanned data to the server 10 (S510), and the server 10 reads predictive digital aligning data stored in the database 140 (S520).

The server 10 compares the scanned dental data and the predictive digital aligning data stored in the database 140 (S530).

When the unit orthodontic dental state data of the patient do not correspond to the predictive digital aligning data set through the artificial intelligence aligning data determiner 120 according to the comparison result, the artificial intelligence controller 130 of the server 10 determines whether this case has happened at least three times (S560).

When it has happened at least three times, and when unit orthodontic state data of the patient show movement of further than the predictive digital aligning data set, the artificial intelligence controller 130 recognizes the tooth moving speed to be faster than a normal speed, and generates new digital aligning data corresponding to the movement (S540).

When the unit orthodontic state data of the patient show movement of less than the predictive digital aligning data set, the artificial intelligence controller 130 recognizes the tooth moving speed to be slower than the normal speed, and generates new digital orthodontic data corresponding to the movement.

If needed, when the unit orthodontic state data of the patient do not correspond to the predictive digital aligning data set at least three times through the aligning data determiner 120, the data generating controller 130 may provide the newly generated predictive digital aligning data set corresponding to the difference between the unit orthodontic state data of the patient and the predictive digital aligning data set to the dentist terminal, and may receive control data of the dentist from the dentist terminal.

If needed, the dentist may first compare the scanned intraoral data and the predictive digital orthodontic data stored in the database 140, and when the comparison results do not correspond to each other, it means that the tooth shift is not performed as predicted, so he may transmit the scanned intraoral data to the artificial intelligence controller 130 and may generate a new predictive digital orthodontic data set.

When it is not at least three times (S560), the data generating controller 130 assigns negative points, and manufactures a clear aligner set of the next step with the stored predictive digital aligning data (S570). If needed, the data generating controller 130 may reflect the difference between the unit orthodontic dental state data of the patient and the predictive digital aligning data set to the predictive digital data.

In another way, when the unit orthodontic dental state data of the patient correspond to the predictive digital aligning data set through the aligning data determiner 120, the artificial intelligence controller 130 of the server 10 assigns a positive point, and manufactures a clear aligner set of the next step with the stored predictive digital aligning data (S550). If needed, the artificial intelligence controller 130 of the server 10 provides it that the unit orthodontic dental state data of the patient correspond to the predictive digital orthodontic data set to the dentist terminal 200 so that the dentist may recognize it.

The positive points and the negative points are assigned by the above-noted process in the treatment process of the corresponding patient, and when the positive points are greater than a predetermined number of points, the server 10 excludes personal information of the patient, classifies the same as good orthodontic data, and stores it in the database 140.

The server 10 continuously learns an average value of the good orthodontic data for respective groups as a best model, thereby acquiring more stable 3D orthodontic models for the respective corresponding groups.

If needed, the server 10 may refer to the best model to provide a target dental state from the present dental data.

While the artificial intelligence algorithm of the server 10 performs repeated orthodontics through reinforcement learning, a final orthodontic form may also be generated as an algorithm.

Therefore, the patient may start treatment after viewing a state of post-completion before treatment starts.

In an exemplary embodiment of the present invention, the orthodontic patient is clustered or grouped through unsupervised learning based on the good orthodontic data excluding personal information of the patient, and the tooth moving plan for orthodontics through repeated reinforcement learning satisfying the orthodontic limit condition suggested by the grouped data and the orthodontics textbook for respective steps.

Also, according to an exemplary embodiment of the present invention, the inside of the synthetic plate is coated with transparent silicone so that it may be smoothly attached to the teeth, thereby increasing the orthodontic effect and protecting the gum.

Further, in an exemplary embodiment of the present invention, the cavity may be prevented by applying fluoride inside the synthetic plate.

In addition, in an exemplary embodiment of the present invention, an infection of the gum may be prevented by applying the hexamedine inside the synthetic plate.

The exemplary embodiments of the present invention may be implemented through the above-described system and/or method, and may also be implemented with a program for realizing the functions corresponding to the elements of the exemplary embodiment of the present invention, and a recording medium storing the program. These implementations may be easily achieved from the description of the exemplary embodiment by a person of ordinary skill in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A stepwise automatic orthodontic system comprising:
a database for storing good dental orthodontic data excluding personal information of a patient, data generated by clustering orthodontic patients or dividing them into a predetermined number of groups through unsupervised learning based on the dental orthodontic data, and a dental orthodontic limit condition presented by a dental orthodontics textbook;
an artificial intelligence orthodontic data generator for determining to which group from among the grouped data of the database the dental data generated by 3D-scanning the dental state of a dental patient belongs, referring to the data of the determined group, gradually moving a tooth that requires orthodontics to generate a predictive digital orthodontic dental data set, and classifying the predictive digital orthodontic data set into a unit digital aligning data group;
an artificial intelligence orthodontic data determiner for comparing unit orthodontic-based dental data of a patient after a clear aligner manufactured corresponding to the unit digital aligning data group is worn and the predictive digital orthodontic dental data set for each the unit digital aligning data group; and
an artificial intelligence controller for assigning a positive point when the unit orthodontic state data of the patient correspond to the predictive digital aligning data set, and assigning a negative point when the unit orthodontic state data of the patient do not correspond to the predictive digital aligning data set through the artificial intelligence aligning data determiner, and storing the point in the database.

2. The stepwise automatic orthodontic system of claim 1, wherein
when a sum of assigned points becomes greater than a predetermined number of points, the artificial intelligence controller stores the same in the database as good dental orthodontic data excluding personal information of the patient.

3. The stepwise automatic orthodontic system of claim 2, further comprising:
a three-dimensional (3D) printer for generating and outputting a dental orthodontic model by using the digital orthodontic data;
a vacuum former for generating a clear aligner by vacuum-compressing a transparent synthetic resin plate on which a transparent silicone is coated to the generated dental orthodontic model; and
a coating device for coating fluorine or hexamedine on the clear aligner generated by the vacuum former.

4. The stepwise automatic orthodontic system of claim 3, wherein
the coating device includes:
a communicator for receiving patient information from the artificial intelligence controller;
a fluoric solution storage unit for storing a fluoric solution;
a hexamedine solution storage unit for storing a hexamedine solution;
a fluoric solution sprayer for spraying the fluoric solution of the fluoric solution storage unit;
a hexamedine sprayer for spraying the hexamedine solution of the hexamedine solution storage unit; and
a coating controller for receiving the age, gum, or cavity information of the patient through the communicator, controlling to coat the hexamedine solution on the clear aligner when the patient has gum disease, and controlling to coat the fluoric solution on the clear aligner when the patient has a cavity.

5. The stepwise automatic orthodontic system of claim 4, wherein
the coating controller receives changing information of the age, gum, or cavity information of the patient through the communicator, controls an amount of the hexamedine solution and controls to coat the same on the clear aligner according to a variation of gum disease information of the patient, and controls an amount of the fluoric solution and controls to coat the same on the clear aligner according to a variation of cavity information of the patient.

6. The stepwise automatic orthodontic system of claim 5, wherein
when the patient has a cavity and gum disease, the coating controller controls the amount of the fluoric solution and coats the same on the clear aligner, and it controls the amount of the hexamedine solution and coats the same on a gum contact portion of the clear aligner.

7. The stepwise automatic orthodontic system of claim 6, wherein
when the gum disease of the patient is determined to improve, the coating controller reduces the amount of the hexamedine solution and coats the same on the clear aligner,
when the gum disease of the patient is determined to become worse, the coating controller increases the amount of the hexamedine solution and coats the same on the clear aligner,
when the cavity of the patient is determined to improve, the coating controller reduces the amount of the fluoric solution and coats the same on the clear aligner, and
when the cavity of the patient is determined to become worse, the coating controller increases the amount of the fluoric solution and coats the same on the clear aligner.

8. A stepwise automatic orthodontic method using an artificial intelligence (Al) technique, comprising:
scanning a dental state of a patient by using an intraoral scanner;
allowing a server to determine to which group of grouped data of the database the scanned dental data belong;
allowing the server to refer to data of the determined group, move a tooth needing orthodontics gradually, and generate a predictive digital orthodontic dental data set;
allowing the server to transmit the orthodontic-processed digital orthodontic dental data set of a patient to a three-dimensional (3D) printer, and allowing the three-dimensional (3D) printer to generate and output a dental orthodontic model; and
generating a clear aligner by vacuum-compressing a transparent synthetic resin plate to the generated dental orthodontic model through a vacuum former.

9. A stepwise automatic orthodontic method using an artificial intelligence technique, comprising:
allowing a coating device to receive age, gum state, or cavity information of a patient from a server through a communicator;
when the patient has gum disease, allowing the coating device to coat a hexamedine solution on a clear aligner;
when the patient has a cavity, allowing the coating device to coat a fluoric solution on the clear aligner;
when the gum disease of the patient is determined to improve, controlling to reduce an amount of a hexamedine solution and coat the same on the clear aligner;
when the gum disease of the patient is determined to become worse, controlling to increase the amount of the hexamedine solution and coat the same on the clear aligner;
when the cavity of the patient is determined to improve, reducing an amount of a fluoric solution and coating the same on the clear aligner;
when the cavity of the patient is determined to become worse, increasing an amount of the fluoric solution and coating the same on the clear aligner.
